(19) United States
(12) Patent Application Publication
(10) Pub. No.: US 2004/0129779 A1
(43) Pub. Date: Jul. 8, 2004

(54) Device for storing and disposing articles for withdrawal

(76) Inventor: Vidar Kvalheim JR., Brattlivn (NO)

Correspondence Address: DENNISON, SCHULTZ, DOUGHERTY & MACDONALD, 1727 KING STREET, SUITE 105, ALEXANDRIA, VA, 22314, US

(21) Appl. No.: 10/475,859

(22) PCT Filed: Apr. 23, 2002
(86) PCT No.: PCT/NO02/00154

(30) Foreign Application Priority Data
May 4, 2001 (NO) 20012210

(51) Int. Cl. G06K 5/00

(52) U.S. Cl. 235/382

(57) ABSTRACT

Device for storage of objects which can be used by arbitrary, identified users, where there is an enclosed space (11) which is closed with a lockable door (12), and where the lockable door (12) is provided with a lock (13) which can be opened with a code or an encoded element, especially and ID-card which requires identification of the user, and where each object which is incorporated in the enclosed space is provided with an individual remotely readable identification, such as an electronic ID-card (18). The enclosed space can be a wardrobe provided with at least one ID-reader (15, 16) which can ascertain the presence of a plurality of objects (17). The ID-readers (15, 16) are prepared to register the presence of an object only when the door (12) to the wardrobe is closed. The ID-reader as well as the lock (13) is connected with a data network for registering user identities and content.

The invention relates to a device as stated in the introductory part of patent claim 1, for keeping and dispensing of objects, with the requirement for restriction of accessibility, especially working clothes for employees.

### BACKGROUND

For different types of objects and equipment it is common that a great number of users shall have access to self-service with taking, where control of taking is maintained simultaneously. An example of this is the distribution of working clothes in hospitals and similar institutions.

The traditional depositing in locked wardrobes or drawers gives no possibility for surveillance and registration of contents and of the persons who take out clothes.

There have been developed different systems for storage and exposing which give the possibility for data-like surveillance. For example it is known to fit out storeroom with transport conveyors which can be unloaded at a dispensing area. This solution takes up room and requires centralised delivery. With this system both equipment costs and application costs are unnecessary high.

For the identification of objects there are known transponders, also called ID-tags, which can be encoded with different information in an element which responds to radio signals and reflects a signal which contains the information. Such transponders are among other things used with cars and other objects which shall be remotely identified.

### OBJECT

The main object of the invention is to create such a device for storage and dispensing of objects, which in connection with working clothes shall able the working clothes to be circulated to a laundry for cleaning and maintenance the device resulting in

better control of delivery

easier access to clean clothes for staff

easier handling for porters

better order and storage control

better order and system

tool for consumption and economy control

better total-economy (economical) textiles

better loss surveillance

shall take little space

shall be adaptable to varying supply (increasing/decreasing)

shall be able to register who takes out clothes (when and what)

shall be able to carry out automatic ordering direct to the laundry (type, wardrobe and time)

shall be able to offer to all registered employees the right type and size 24 hours a day the whole year

shall be able to accurately register which clothes are in the automat at any time

shall be able to register the consumption per employee and ward/department of all types of units which are used in the automat

shall be able to give the the user institution the possibility to authorize user and to adjust the ordering routine

shall be able to make use of web-based database solutions

shall be able to be used independent of building, floor or the remaining automates or deliverers

there shall be as few as possible mechanical parts and therewith minimal need for maintenance

shall be able to be installed without modifications on the part of the building.

A corresponding list also applies where the device is used for storage and dispensing of other types of objects.

### INVENTION

The invention is indicated in patent claim 1. Further details are quoted in patent claims 2-6. With this form of execution is it possible to meet the requirements which are listed above in a better way than with known corresponding devices.

### EXAMPLE

Below the invention is described in greater detail by referring to the drawings in which is illustrated a wardrobe for storage and dispensing of working clothes at a treatment institution like a hospital.

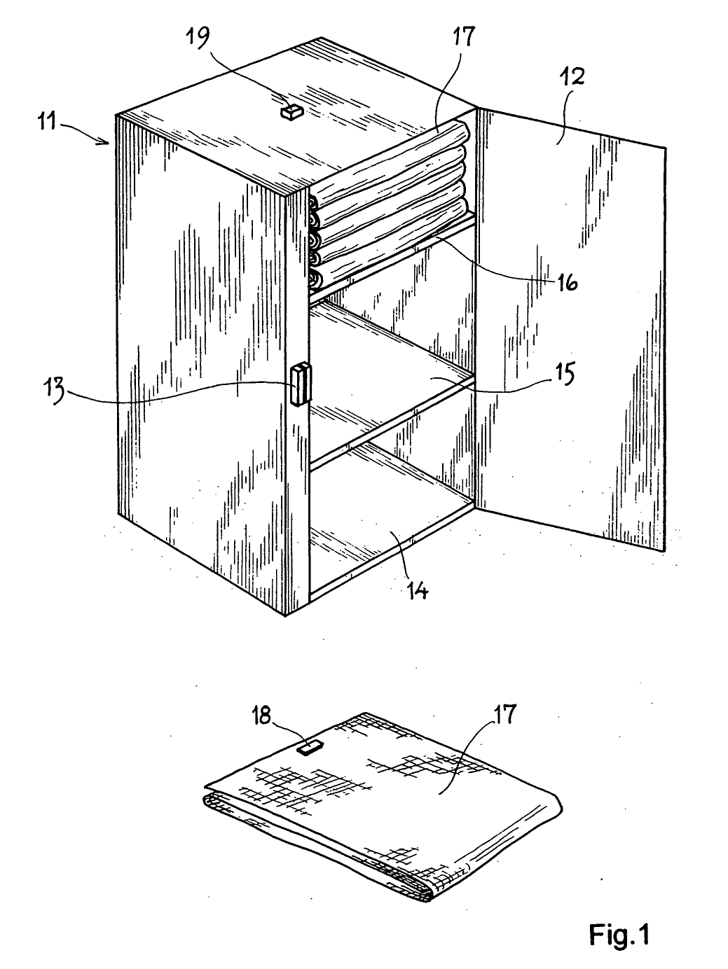

FIG. 1 is a perspective view of a wardrobe which can be used with a device according to the invention, and

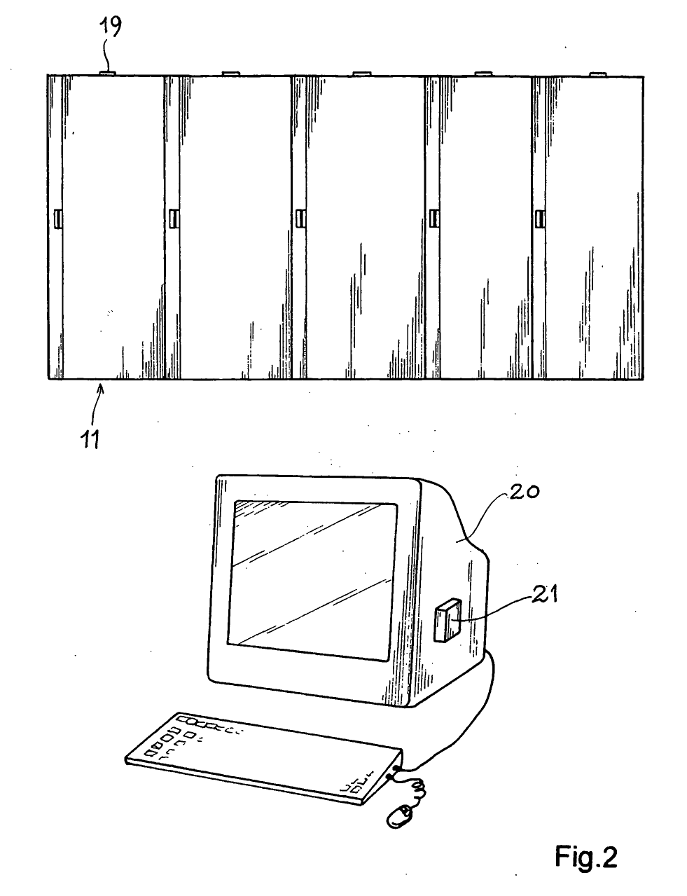

FIG. 2 is a schematic illustration of an arrangement of several wardrobes and data processing equipment for controlling the device.

FIG. 1 shows a wardrobe 11 which has a front door 12 with a lock 13 which can be operated with an ID-card. The expression ID-card is primarily intended to mean an ID-card which staff of an institution may carry for opening of doors or for documenting the right of entrance. It also can mean credit card or other forms of electronic identity cards, for example bank card, which is associated with persons or groups. Alternatively the lock can contain an encoding panel or a common key or padlock.

The wardrobe 11 has a bottom 14, a lower shelf 15 and an upper shelf 16. The shelves 15 and 16 both are supporting structure, for example in the form of plates, and at the same time reader for ID-tags which are to be placed in the wardrobe.

Objects which, in this example, are to be placed in the wardrobe are working clothes 17 which are provided with firmly fixed ID-tags 18. The expression “ID-tag” is meant to indicate an element which can carry information about different factors and which can be interrogated remotely. In its most simple form a bar code can be used. However, a bar code has restricted information capacity and is difficult to read. Therefore in practice it will be appropriate to use an electronic ID-tag, where one can store several informations and where interrogation of the tag can take place with the aid of a radio wave transmitter which receives reflected signals from the ID-tag. An example of such ID-tags is TaxATag (trademark) from Q-Free ASA. In this case the two shelves 15 and 16 are executed in the form of such radio wave transmitters which can receive reflected signals from the individual ID-tag 18 which are located in the wardrobe 11.

The ID-tag 18 can contain information about type of cloth, size, year of manufacture, number of washing operations, owner, buying date, producer and so on.

The ID-readers 15 and 16 as well as the ID-lock 13 are connected to a data network. This can take place over an IR-transmitter 19 which is placed on top of the wardrobe or with corresponding bluetooth-technology. In this way two or more wardrobes of this kind can be set up side-by-side or be localized in a department and be operated as an unit.

The ID-readers 15 and 16 are disabled for reading when the door 12 is open. This prevents registration of working clothes of those who attends to the wardrobe 11 or who are in some other way closely adjacent.

### FUNCTION

The insertion of working clothes 17 into the wardrobe 11 will be registered for the individual object. If a user takes out a piece of clothing this will be ecntrally registered. Accordingly, an overall view can be obtained regarding available cloth with regard to type, size and location. This makes it possible to reduce the stored quantity and reduces the circulation time. Generally this will result in a total logistics between producer, supplier, customer/client and user, with the possibility for complete order- and stock-control.

FIG. 2 shows several wardrobes 11 located at side by side in a row and five in this example five in number. In another arrangement several wardrobes can be spread out in groups over a floor. Each wardrobe is provided with an IR-transmitter 19 located at the top. There is also shown data processing equipment 20 which serves as main station for registering movement of objects to and from the wardrobe. It is provided with an IR-transmitter 21 for communication with the IR-transmitter 19 of the wardrobe.

### MODIFICATIONS

Instead of filling the wardrobe from a local transport container, the whole wardrobe can be re-circulated to the laundry, or taken to a central receiving station for filling up from a bulk transport container which is taken to and from the laundry.

Instead of the wardrobes as illustrated, a specially built storage room with shelves and/or drawers can be used. There also can be provided a large storage room with conveyors, but this will require more space and a longer access time for the individual users.

The invention can be used for storing and dispensing other different other objects where there exists a risk for loss and where one wishes a service-free, user-controlled operation, for example tools is a workplace, for books in a library and for different vending machines.

1. Device for storage of objects which can be used by arbitrary, identified users, where there is an enclosed space (11) which is closed with a lockable door (12), and where the lockable door (12) has a lock (13) which can be opened with a code or an encoded element, especially an ID-card, which requires identification of the user, and where each object which is kept in the space is provided with an individual remotely readable identification device, such as an electronic ID-tag (18), characterized in
that the space is provided with at least one ID-reader (15, 16) which can ascertain the presence of a plurality of objects (17),
that the ID-reader (15, 16) is operative to register the presence of an object only when the door (12) is closed, and
that the ID-reader as well as the lock (13) is connected with data processing equipment (20) for registering user identities and content.

2. Device according to claim 1, characterized in that the keeping room is a wardrobe (11).

3. Device according to claim 2, characterized in that the several wardrobes (11) are prepared for communication in a common system.

4. Device according to claim 2 or 3, characterized in that each wardrobe is provided with a communications unit (19), such as an ID-transmitter, for wireless communication with data processing equipment (20).

5. Device according to anyone of claims 1 to 4, where the space is provided with at least one shelf (14), characterized in that there into the shelf (14) or shelves is/are fitted or integrated with an antenna for radiating and receiving of signals to and from the identification device (18).

6. Device according to anyone of claims 1 to 5, characterized in that the data processing equipment (20) is prepared to supervise the stock of objects of different type in unequal spaces in an arrangement with several spaces in groups, and register the taking or insert of objects, identity of users who open a space for supply to or removal from the space.
